(19) United States
(12) Patent Application Publication
(10) Pub. No.: US 2006/0062288 A1
(43) Pub. Date: Mar. 23, 2006

(54) Short loop ADSL power spectral density management

(75) Inventor: Richard K. Hester, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/231,248

(22) Filed: Sep. 20, 2005

Related U.S. Application Data
(60) Provisional application No. 60/611,628, filed on Sep. 21, 2004.

(51) Int. Cl. H04L 5/16

(52) U.S. Cl. 375/222

(57) ABSTRACT

A digital subscriber line (DSL) modem for a service area interface, which controls the power of its downstream transmissions to minimize far-end crosstalk (FEXT), is disclosed. The disclosed modem has an interface to a low-attenuation upstream facility, such as fiber optic, and includes a digital transceiver and an analog front end that is coupled to a twisted-pair wire facility in a binder. The modem also includes a memory location for storing the feeder distance between a DSL central office and the service area interface, the service area interface also coupled to a subscriber of the CO-fed communications via twisted-pair wire. Power cutback levels are applied to the downstream transmissions from the modem according to the feeder distance, so that the FEXT on the CO-fed signal is minimized without undue data rate degradation.

### CROSS-REFERENCE TO RELATED APPLICATIONS

This application claims priority, under 35 U.S.C. §119(e), of Provisional Application No. 60/611,628, filed Sep. 21, 2004.

### STATEMENT REGARDING FEDERALLY SPONSORED RESEARCH OR DEVELOPMENT

Not applicable.

### BACKGROUND OF THE INVENTION

This invention is in the field of data communications, and is more specifically directed to power spectrum control for discrete multitone modulation communications.

Digital Subscriber Line (DSL) technology has become one of the primary technologies in the deployment of high-speed Internet access in the United States and around the world. As is well known in the art, DSL communications are carried out between a central office (CO) location, operated by a telephone company or an Internet service provider, and individual subscribers, using existing telephone “wire” facilities. Typically, some if not all of the length of the loop between the CO and the customer premises equipment (CPE) is implemented by conventional twisted-pair copper telephone wire. Remarkably, modern DSL technology is able to carry out extremely high data rate communications, even over reasonably long lengths (e.g., on the order of 15,000 feet) of twisted-pair wire, and without interfering with conventional voiceband telephone communications.

Modern DSL communications achieve these high data rates through the use of multicarrier modulation (MCM) techniques, also referred to as discrete multitone modulation (DMT), by way of which the data signals are modulated onto frequencies in a relatively wide frequency band (on the order of 1.1 MHz for conventional ADSL, and up to as high as 30 MHz for VDSL), residing well above the telephone voice band, and subdivided into many subchannels. The data symbols modulated onto each subchannel are encoded as points in a complex plane, according to a quadrature amplitude modulation (QAM) constellation. The number of bits per symbol for each subchannel (i.e., the “bit loading”), and thus the number of points in its QAM constellation, is determined according to the signal-to-noise ratio (SNR) at the subchannel frequency, which depends on the transmission channel noise and the signal attenuation at that frequency. For example, relatively noise-free and low attenuation subchannels may communicate data in ten-bit to fifteen-bit symbols, represented by a relatively dense QAM constellation with short distances between points in the constellation. On the other hand, noisy channels may be limited to only two or three bits per symbol, allowing a greater distance between adjacent points in the QAM constellation. High data rates are attained by assigning more bits (i.e., a more dense QAM constellation) to subchannels that have low noise levels and low signal attenuation, while subchannels with poorer SNRs can be loaded with a fewer number of bits, or none at all.

The most popular implementation of DSL is asymmetric DSL (“ADSL”), which follows a frequency-division duplexing (FDD) approach in that “downstream” communications from the telephone company central office (“CO”) to customer premises equipment (“CPE”) are in one frequency band of the spectrum, and “upstream” communications from the CPE to the CO are in another, non-overlapping, frequency band. For example, “downstream” communications (CO to CPE) in modern ADSL typically occupy 224 subchannels of 4.3125 kHz bandwidth, while upstream communications use 32 such subchannels at lower frequencies than the downstream band (but still above the voice band). ADSL can also be implemented in an echo-cancelled mode, where the downstream frequency band overlaps the upstream frequency band. However, this so-called “overlapped mode” of operation is not widely deployed. In any case, the asymmetry suggested by the acronym “ADSL” refers to the wider and higher-frequency band that is assigned to downstream communications, relative to the narrower, lower-frequency, upstream band. As a result, the ADSL downstream data rate is typically much greater than the upstream data rate, except in those cases in which the loop length is so long that the downstream frequency band becomes mostly unusable. Newer DSL technologies provide higher data rates by variations of the DMT scheme of ADSL. For example, “ADSL2+” extends the data bandwidth to 2.2 MHz using 512 subchannels, and also provides an optional mode in which the upstream data rate can be doubled. Very high bit-rate DSL (“VDSL”) provides extremely high data rates via up to 4096 subchannels, at frequencies extending up to 30 MHz.

In addition to the bit loading and SNR of the subchannels, the available power for DSL transmission is a factor in the actual data rate that can be achieved. Given sufficient power, the signal strength relative to noise can be made high enough for a given subscriber loop that any reasonable data rate can be achieved. But the power levels for communication over a given subscriber loop are in fact limited, primarily because of crosstalk among subscriber loops that are carried over physically adjacent wire facilities. As known in the art, many conventional telephone wire lines are physically located within “bundles” for at least some distance over their length between the CO and the customer premises. This close physical proximity necessarily causes signal crosstalk between physically adjacent conductors in the bundle. The channel characteristics for each DSL user within a bundle thus depend not only on the signal power for that use, but also the signal power of the other users in the bundle and the crosstalk coupling of the signals from those other users. As such, the power level for DSL communications must be limited so that crosstalk among conductor pairs in a bundle can be kept within a reasonable level.

Historically, DSL systems typically consider the problem of crosstalk and power constraints as a “single-user” problem. Modern standards for DSL communication, such as the G.992.1 standard entitled “Asymmetric digital subscriber line (ADSL) transceivers”, promulgated by the International Telecommunications Union, follows this assumption by enforcing a specified power spectral density (PSD) over the entire DSL frequency band for each user. This specified PSD keeps any particular subscriber loop from dominating others in the binder with excessive power, and thus enables reasonable data rates for a large number of subscribers. In addition, this “single-user” solution is easy to implement. However, the enforcing of a specified PSD keeps the overall system from maximizing data rates, by increasing the PSD levels, in those environments in which a higher PSD would not unduly degrade the signal for other users.

But recent advances in the availability of online content, and more widespread deployment of high-speed Internet access, have resulted in increasing demand for higher data rates over DSL connections. In one approach, referred to as very-high bit rate digital subscriber lines (VDSL), the higher data rate is achieved by using higher frequency bands; unfortunately, the crosstalk problem becomes even more severe at higher frequencies. And the widespread popularity of high data rate services are now becoming served through the use of optical fiber facilities for at least part of the length of many subscriber loops, and the deployment of other equipment to extend the reach of DSL service.

However, optical network units (ONUs) that interface optical fiber to twisted-pair wire, and remote “DSLAMs” (Digital Subscriber Line Access Multiplexers) that move some of the CO functionality into the field, are notorious sources of additional crosstalk. Worse yet, these remote terminals (RTs) implemented as ONUs and DSLAMs give rise to a so-called “near-far” problem, in that two transmitters (the CO and an ONU, for example) are sourcing interference from different distances from one another; the nearer source of crosstalk, for a given user, will necessarily be stronger than the signal from the more remote source in the loop, thus calling into question the common distance assumption of the fixed PSD limit in conventional DSL. The competing factors of higher data rates and exacerbated crosstalk are thus exerting pressure onto other constraints of DSL technology. As mentioned above, one such constraint is the single-user assumption and the resulting specified PSD limits.

The near-far problem is especially exacerbated in current DSL deployment schemes, in which both legacy CO-CPE subscriber loops, which use twisted-pair wire media for the entire length of the lop, and also “short loop” DSL loops in which fiber optic media carries the communications for much of the loop length, with twisted-pair wire used for only a short remaining distance to the CPE. Typically, in this current arrangement, a service area interface (SAI) is provided in the “neighborhood” of a number of clients, typically at distances less than about 6000 feet from the furthest client premises. The typical SAI includes both a passive cross-connect function for the legacy CO-CPE subscriber loops, connecting a “feeder” loop between the CO and the SAI to a “distribution” loop between the SAI and the corresponding CPE for that loop, and also an optical network unit (ONU) that interfaces to a fiber optic facility on one side, and includes a conventional “ATU-C” DSL modem transceiver for carrying out DSL communications with the CPE of subscribers to the corresponding service. As such, DSL communications are carried out from each SAI to all of its corresponding subscribers, some of which are served by a conventional DSL CO (such communications referred to in this description as “CO-fed” communications), and the others of which are served by a CO communicating over fiber optic to the ONU at the SAI (such communications referred to in this description as “SAI-fed” communications).

A significant limitation on the data rate performance in a system including an SAI is the effect of so-called “far-end” crosstalk, or FEXT. FEXT refers to crosstalk interference sensed by a receiver from unrelated transmissions in the same direction, typically coupling over wires that are physically near one another. In the arrangement discussed above in which adjacent communications facilities carry both SAI-fed and CO-fed signals, FEXT interference is dominated by the signal levels of the downstream SAI-fed signals from that interfere with the downstream CO-fed signals. This dominance results from the SAI-fed DSL signal attenuating substantially less over its short distribution loop (SAI to CPE) relative to the attenuation of the CO-fed DSL signal over the much longer loop including both the feeder loop (CO to SAI) and its distribution loop (SAI to CPE). This FEXT interference is the manifestation of the “near-far” problem mentioned above.

FIG. 1 illustrates an example of the power (power spectral density, or PSD) of FEXT received at CPE installations for an example in which the feeder loop length from the CO to the SAI is 6000 feet, and in which the distribution lengths from the SAI to the CPE installations are each 3000 feet. In this example, the power of the SAI-fed FEXT is illustrated by curve 17, while the power of the CO-fed FEXT is illustrated by curve 19; line 18 refers to the noise floor at the respective CPE 8, by way of reference. As evident from FIG. 1, the power of the SAI-fed FEXT remains well above the power of the CO-fed FEXT at most useful downstream frequencies. As such, one can readily see that the SAI-fed FEXT will be much greater than that the CO-fed FEXT, due to the attenuation over the feeder loop TWPF. The power of the CO-fed FEXT will dip lower with increasing feeder loop length L_{feeder}, of course.

Accordingly, it has become tempting to attempt to manage the PSD for DSL communications in order to achieve higher data rate communications in this modern context. In one approach, described in Yu et al., “Distributed Multiuser Power Control for Digital Subscriber Lines”, Journal on Selected Areas in Communications, Vol. 20, No. 5 (IEEE; June, 2002), pp. 1105-15, the individual loops in a multi-user DSL environment negotiate power and frequency usage with one another. According to this fully distributed approach, each subscriber loop derives an optimal power allocation and data rate assignment over the subchannels for itself, considering the crosstalk from all other users as noise, and this allocation is successively applied by each of the other users, and iteratively repeated over all users, until convergence. Once this occurs, then each user's total power output is adjusted according to whether the date rate for that user has reached its target data rate; if the data rate is too low, that user increases its total power, or if a user's data rate is well above its target data rate, that user decreases its total power. The “inner loop” of power allocation and data rate assignment is then repeated by all users until convergence, followed by another iteration of total power adjustment relative to data rate. Once all users have converged on an allocation in which they each meet their target data rates, according to this approach, steady-state communications for all users can commence.

In contrast to this fully distributed approach, a centralized power management has the potential to further optimize data rates among multiple users by managing the PSD of each subscriber loop. One such centralized approach is described in Cendrillon et al., “Optimal Multi-user Spectrum Management for Digital Subscriber Lines”, 2004 IEEE International Conference on Communications, Vol. 1 (Jun. 20-24, 2004), pp. 1-5. In this approach, the optimization problem is considered as a Lagrangian, in which a weighted sum of the data rates of two users (a subscriber of interest, and an interferer, for example) is optimized relative to one another, and in a manner that places the appropriate importance on the total power constraints of the users. The weighting factor of the data rates in the weighted sum is modified in an outer loop, with the goal of maximizing the data rate of the interferer while still achieving the target data rate for the subscriber of interest. Inner loops, within this outer loop, determine two Lagrangian multipliers that define the weight of the power constraints of the two users, given the bit loadings of each. According to this approach, a centralized spectrum management center (SMC) is responsible for setting the power spectra for all of the users within the communications network. Optimization of the system in this manner thus requires various parameters (bit loading, channel characteristics, etc.) to be communicated from each user to the SMC for these calculations. As such, this approach requires substantial computational, monitoring, and communications capability at the SMC, necessarily involving substantial cost and power consumption.

By way of still further background, copending application Ser. No. 11/003,308, filed Dec. 2, 2004, and entitled “Semi-Distributed Power Spectrum Control For Digital Subscriber Line Communications”, describes a digital subscriber line (DSL) system in which each DSL loop in the network optimizes its power spectral density while accounting for crosstalk from other users and loops, including those of differing distances (source to destination). The optimization method is based on maximizing the data rate of an interfering user upon a given user, subject to a constraint that the given user data rate must meet its target data rate, and is decomposed into two optimization problems, one solved at the given user and one solved at the interfering user. Adjustment of a weighting factor, or Lagrangian multiplier, is based on a comparison of the power spectral density of the interfering user to a maximum tolerable level at the given user; this comparison is effected at a network management center, which in turn communicates any resulting adjustment in the weighting factor to the two users.

Of course, the problem of SAI-fed FEXT on CO-fed DSL transmissions will be obviated upon the replacement of all twisted-pair wire feeder loops with fiber optic media. However, the infrastructure costs of replacing all such twisted-pair wire facilities is sufficiently high that the mixing of CO-fed and SAI-fed communications at the SAI is contemplated to be desirable for years to come.

By way of still further background, conventional DSL communications, according to the well-known ADSL and ADSL2 standards, involving the performing of “power cutback” functionality. Because of interference and signal clipping that can occur if the power of a transmitted signal is excessive, the power cutback operation permits the transceivers on each end of a subscriber loop to request a cutback in transmit power from the other transceiver. In conventional ADSL communications, as described in Asymmetric digital subscriber line transceivers (ADSL), ITU-T Recommendation G.992.1 (International Telecommunications Union, June 1999), power cutback is effected during initialization, in which the central office (or SAI) DSL modem reduces its downstream transmit power in response to the measured upstream power exceeding a specified level. According to more advanced ADSL standards, as described in Asymmetric digital subscriber line transceivers 2 (ADSL2), ITU-T Recommendation G.992.3 (International Telecommunications Union, July 2002); and Asymmetric Digital Subscriber Line (ADSL) transceivers—Extended bandwidth ADSL2 (ADSL2+), Recommendation G.992.5 (International Telecommunications Union, May 2003), each of the transceivers request power cutback levels in each of the upstream and downstream directions, with the larger requested power cutback level then implemented at the appropriate transmitter. The power cutback levels are requested by a transceiver for its own transmissions in order to reduce power consumption, and are requested by a transceiver for its received signals considering the dynamic range of its own receiver and the current line conditions. According to each of these standards, the specific power cutback level can vary. For example, in the ADSL standard, the power cutback level can range up to as much as −12 dBm/Hz; in the ADSL2 context, the power cutback level can range up to as much as −40 dB.

Another constraint presented in conventional SAI-based distribution systems is the electrical power consumption of the SAI. It is highly desirable, from the standpoint of the DSL service provider, that the service area interface equipment be line-powered, in other words with all power for the functionality at the SAI coming from the lines fed by the corresponding COs. The cost and difficulty of running separate electrical power to the SAI (including the metering of that power) is prohibitive, in that, if such separate power is required, such SAI equipment likely could not be profitably deployed. This constraint of course necessitates minimizing power dissipation by the ONU and DSL modem functionality contained within the SAI.

### BRIEF SUMMARY OF THE INVENTION

It is therefore an object of this invention to provide a system and method for reducing the far-end crosstalk generated by remotely located digital subscriber line transmissions, as received on central-office fed communications.

It is a further object of this invention to provide such a system and method in which the data rate performance at customer premises equipment receiving central office-fed transmissions is not noticeably degraded by the deployment of service area interface-fed communications over a neighboring twisted-pair facility in the same physical binder.

It is a further object of this invention to provide such a system and method that requires minimal additional power dissipation at service area interface equipment.

Indeed, it is a further object of this invention to provide such a system and method that can substantially reduce the power dissipation at service area interface equipment.

It is a further object of this invention to provide such a system and method that may be realized in a manner that is transparent to customer premises equipment and to central office equipment.

It is a further object of this invention to provide such a system and method that operates autonomously with respect to the network, without requiring communication with other network nodes.

Other objects and advantages of this invention will be apparent to those of ordinary skill in the art having reference to the following specification together with its drawings.

The present invention may be implemented into transceiver circuitry and functionality that may be deployed at a service area interface in a digital communications network, and that communicates by way of a digital subscriber line (DSL) medium with one or more transceivers at client premises. The transceiver reduces the power level of its transmissions based on the length of a feeder loop between a system central office (CO) and the service area interface, over which CO-fed communications are being communicated to a client premises, typically over a medium physically near the medium driven by the transceiver itself. The reduced power level for transmissions source by the transceiver itself reduces far-end crosstalk on the CO-fed loop, ensuring no degradation in data rate on that CO-fed loop.

According to another aspect of the invention, data rate capacity can be optimized by including factors such as distribution loop length, as reflected in upstream signal power from the client premises, into the determination of the power cutback level. The data rate capacity can be further optimized by applying frequency-dependent power cutback levels to the downstream communications, which can minimize SAI-fed FEXT on the CO-fed signal with even less impact on the SAI-fed downstream data rate.

### BRIEF DESCRIPTION OF THE SEVERAL VIEWS OF THE DRAWING

FIG. 1 is a plot illustrating the power spectral density of signals, as received at client premises, of digital subscriber line (DSL) signals communicated from a central office (CO) and from a service area interface (SAI) relative to one another.

FIG. 2 is an electrical diagram, in block form, of a communications system constructed according to the preferred embodiment of the invention.

FIG. 3 is an electrical diagram, in block form, of a DSL modem constructed according to a first preferred embodiment of the invention.

FIG. 4 is a data flow diagram illustrating DSL communications according to the preferred embodiment of the invention.

FIG. 5 is a plot illustrating the power spectral density of signals, as received at client premises, of digital subscriber line (DSL) signals, as a function of frequency and of loop length.

FIG. 6 is a plot illustrating a set of power cutback levels as a function of CO-fed feeder loop length and measured upstream power.

FIG. 7 is a flow chart illustrating the initialization of a DSL communications session according to the preferred embodiments of the invention.

FIG. 8 is a plot illustrating the effects of the preferred embodiment on CO-fed data rate performance, for varying feeder loop lengths.

FIG. 9 is an electrical diagram, in block form, of a DSL modem constructed according to a second preferred embodiment of the invention.

### DETAILED DESCRIPTION OF THE INVENTION

The present invention will be described in connection with its preferred embodiment, namely as implemented into remote terminal equipment as used in a digital subscriber line (DSL) communications system. However, it is contemplated that this invention may also benefit the performance of other types of communications systems, particularly those in which crosstalk caused by a “near-far” deployment affects the data rate performance. Accordingly, it is to be understood that the following description is provided by way of example only, and is not intended to limit the true scope of this invention as claimed.

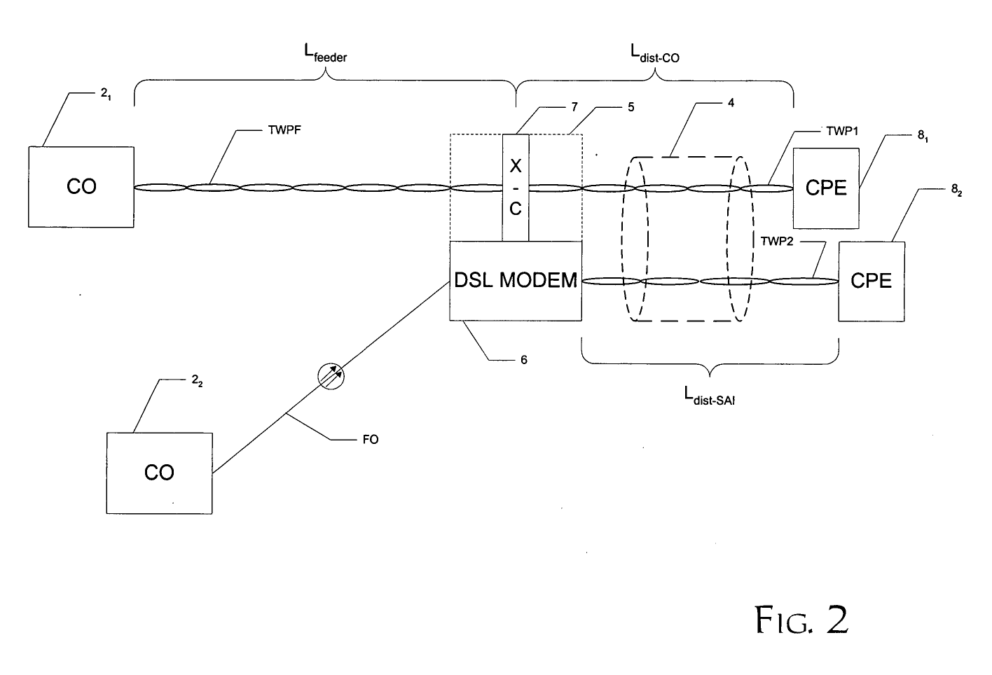

FIG. 2 illustrates an example of a DSL system in which a service area interface (SAI), constructed according to the preferred embodiment of this invention. supports both CO-fed and SAI-fed communications. In this example, central office (CO) 2₁ communicates with SAI 5 over a conventional twisted-pair wire facility TWPF, having a length L_{feeder}, for eventual communication with customer premises equipment (CPE) 8₁ via distribution side twisted-pair wire facility TWP1, which has a loop length L_{dist-CO}. For this conventional CO-fed DSL subscriber loop, SAI 5 includes a simple, passive, cross-connect X-C, typically embodied as consisting of jumpers and terminals. In this conventional example, a second subscriber loop is supported, with CO 2₂ communicating over fiber optic facility FO with DSL modem 6, serving as an optical network unit (ONU) within SAI 5. DSL modem 6 is constructed substantially as a central-office side DSL modem (i.e., as an “ATU-C” as referred to in the various DSL standards), and supports conventional ADSL communications with CPE 8₂ over twisted-pair wire facility TWP2, with a distribution loop length of L_{dist-SAI} as shown. In this example, twisted pair facilities TWP1, TWP2 are realized within a single physical binder 4, as is typical for communications emanating from a service area interface such as SAI 5.

In the system of FIG. 2, the close physical proximity of the wires within binder 4, typically result in far-end crosstalk (FEXT) among the various signals communicated over those wires. As known in the art, FEXT refers to crosstalk interference sensed by a receiver from unrelated transmissions in the same direction (e.g., downstream from SAI 5) where the communications media are physically near one another, such as in the same binder 4 as shown in FIG. 2. In the example of FIG. 2, FEXT interference will be dominated by the signal levels of the downstream SAI-fed signals from DSL modem 6 over twisted-pair facility TWP2 interfering with the downstream signals over twisted-pair facility TWP1 at CPE 8₁. This dominance is because the DSL signal sourced by DSL modem 6 attenuates less over the short loop of TWP2 (of length L_{dist-SAI}) than does the DSL signal sourced by CO 2₁ over the much longer loop of facilities TWPF and TWP1 (having a total length of the sum of loop lengths L_{feeder} and L_{dist-CO}). This dominating FEXT is the manifestation of the “near-far” problem discussed above in connection with the background of the invention, and addressed according to the preferred embodiment of the invention as will be described in this specification.

According to the preferred embodiment of the invention, as will be described in further detail below, DSL modem 6 includes functionality for reducing the FEXT of transmissions over twisted-pair facility TWP1 as sensed by CPE 8₁, by intelligent selection of the power spectral density (PSD) of the downstream DSL transmissions over facility TWP2.

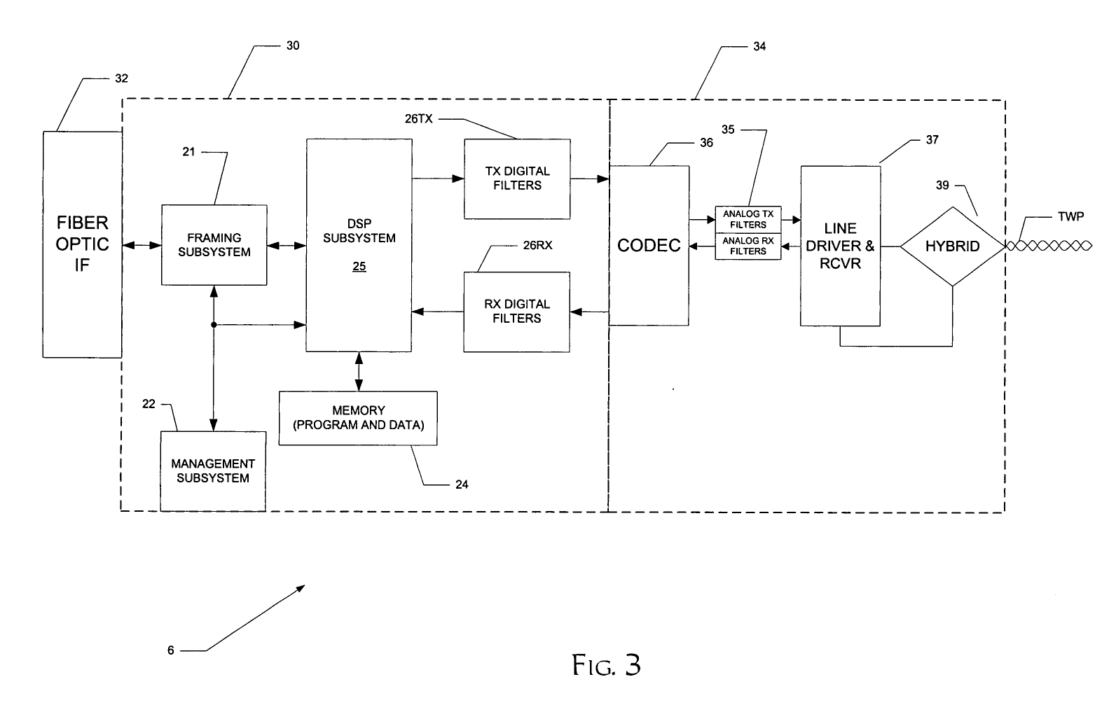

Referring now to FIG. 3, the construction of DSL modem 6 in SAI 5 according to a preferred embodiment of the invention will now be described. The construction of DSL modem 6 shown in FIG. 3 is provided by way of example only, and is meant only to illustrate a possible modem architecture into which the preferred embodiment of the invention may be implemented. Of course, the invention may be implemented into DSL modems of different architectures, and into communications equipment of similar and different architectures for different communications applications.

DSL modem 6 is effectively a transceiver, in the sense that it can both transmit and receive signals over twisted pair facility TWP. According to this preferred embodiment of the invention, DSL modem 6 includes digital transceiver 30, which is coupled to interface 32 for communicating with an upstream network element, such as central office 2₂ of FIG. 2, for example. In this example, as evident from the system diagram of FIG. 2, interface 32 interfaces with fiber optic facility FO, and as such includes the appropriate physical interface functionality, as well as the computational capability for processing the communicated signals and data between the relevant fiber optic format and protocol and that involved in DSL communications. For purposes of this description, it will be assumed that this formatting, for communications to be transmitted to CPE 8₂, will place the signals received over fiber optic facility FO into the form of a digital baseband bitstream.

Digital transceiver 30 may support one communications port, such as shown in FIG. 2 in which digital transceiver 30 is connected to a single instance of analog front end 34, which in turn couples to twisted-pair wire facility TWP. Alternatively, digital transceiver 30 may support multiple communications ports, in which case each port would be realized by an instance of analog front end 34. Analog front end 34 in this example includes hybrid circuit 39, which is a conventional circuit that is connected to transmission loop LP, and that converts the two-wire arrangement of the twisted-pair facility to dedicated transmit and receive lines connected to line driver and receiver 37, considering that bidirectional signals are communicated over facility TWP by DSL modem 30. As will be described below, it is contemplated that the power reduction provided by DSL modem 6 according to the preferred embodiment of the invention may control the transmitted and received signals to such an extent that hybrid circuit 39 is unnecessary.

Line driver and receiver 37 is a high-speed line driver and receiver for driving and receiving ADSL signals over twisted-pair lines. Line driver and receiver 37 is bidirectionally coupled to coder/decoder (“codec”) circuit 36 via analog transmit and receive filters 35. Codec 36 in analog front end 34 performs the conventional analog codec operations on the signals being transmitted and received, respectively. These functions include digital and analog filtering, digital-to-analog conversion (transmit side), analog-to-digital conversion (receive side), attenuators, equalizers, and echo cancellation functionality, if desired. Examples of conventional devices suitable for use as analog front end 34 according to the preferred embodiment of the invention include conventional integrated analog front end devices, such as the TNETD7122 and 7123 integrated AFE circuits available from Texas Instruments Incorporated.

As shown in FIG. 3, digital transceiver 30 includes framing subsystem 31, which is coupled to the fiber optic side of transceiver 30, and which formats digital data to be transmitted into frames, or blocks, for modulation and transmission. DSP subsystem 25 of digital transceiver 30 is preferably one or more digital signal processor (DSP) cores, having sufficient computational capacity and complexity to perform much of the digital processing in the encoding and modulation (and demodulation and decoding) of the signals communicated via digital transceiver 30. Transceiver 30 also includes memory resources 24, including both program and data memory, accessible by DSP subsystem 25 in carrying out its digital functions, for example according to software stored in memory resources 24. These digital functions include the IDFT modulation (and DFT demodulation of received signals), appending (and removal) of cyclic extensions, among other conventional digital functions.

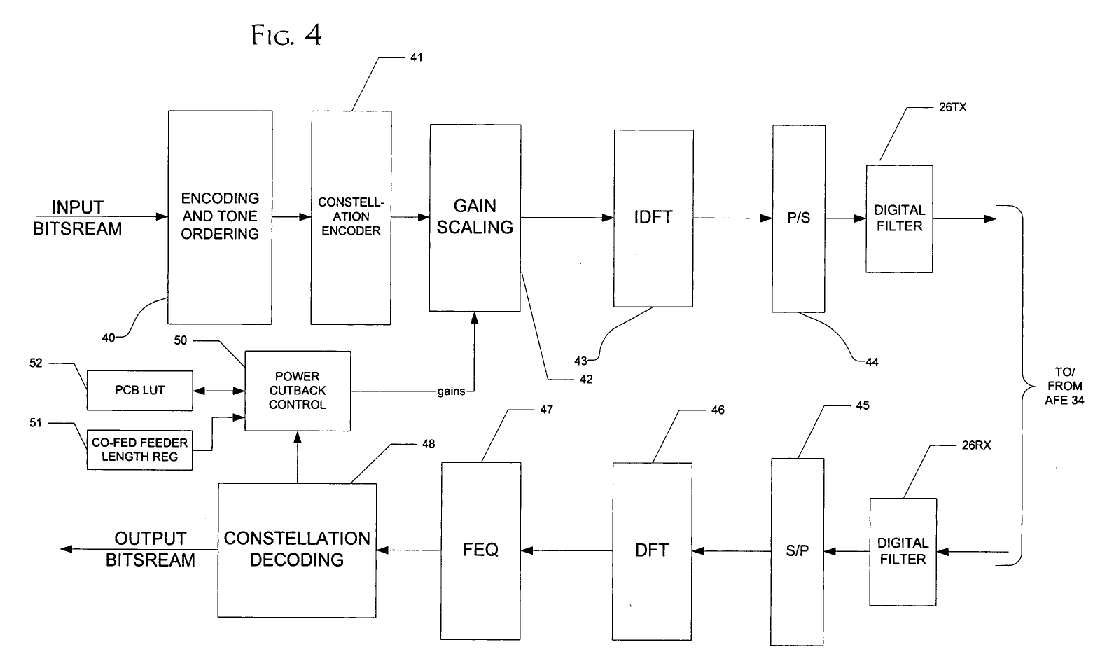

As shown in FIG. 3, digital transceiver 30 also includes transmit and receive digital filters 26TX, 26RX, respectively, for applying the appropriate filter functions to the transmitted and received signals, respectively. Digital filters 26TX, 26RX may be executed by DSP subsystem 25 according to the corresponding software routines, as known in the art, or alternatively may be realized as separate hardware resources as suggested by FIG. 4. Management subsystem 22 implements and effects various control functions within digital transceiver 30, communicating with each of the major functions of digital transceiver 30 to control its operation according to the desired number of ports to be supported.

As mentioned above, the architecture shown in FIG. 2 is presented by way of example only. Alternative architectures for DSL modem communication, and for other multicarrier modulation communication systems such as OFDM wireless communications, are also contemplated to be within the scope of the invention, and may be implemented by those skilled in the art having reference to this specification, without undue experimentation.

Referring now to FIG. 4, a data flow architecture executable by digital transceiver 30 in transmitting and receiving DSL communications, according to the preferred embodiment of the invention, will be described. As mentioned above, these operations are preferably executed by programmable logic, such as DSP subsystem 25 executing program instructions stored in program memory of memory resource 24, for example; alternatively, more customized and dedicated logic and circuitry may carry out these operations.

On the transmit side, an input bitstream from fiber optic interface 32 (FIG. 3) is received at encoding and tone ordering function 40, which groups the bitstream into multiple-bit symbols that are used to modulate the DMT subchannels, with the number of bits in each symbol determined according to the bit loading assigned to its corresponding subchannel of the set of discrete multitone modulation (DMT) subchannels, the number of bits based on the characteristics of the transmission channel as determined in DSL initialization. Encoding and tone ordering function 40 may also include other encoding functions, such as Reed-Solomon or other forward error correction coding, trellis coding, turbo or LDPC coding, and the like. These encoded symbols are then applied to constellation encoder 41, which associates each symbol with points in the appropriate modulation constellation (e.g., quadrature amplitude modulation, or QAM), each associated with one of the DMT subchannels. Gain scaling function 42 applies a gain value to the encoded amplitude for each subchannel, these gain values including a clip prevention signal in the encoded signals to be modulated, to reduce the peak-to-average ratio (PAR) as transmitted as described in copending application Ser. No. 10/034,951, filed Dec. 27, 2001, published on Nov. 28, 2002 as U.S. Patent Application Publication No. 2002/0176509, incorporated herein by this reference. Gain scaling function 42 also determines the gain values for each subchannel according to the desired transmit power spectrum density (PSD) for the transmission. According to the preferred embodiment of the invention, these gain values are derived, in part, under the control of power cutback control function 50, which applies a power cutback value selected so that FEXT generated by the transmitted signal is minimized. According to the preferred embodiment of the invention, as will be described in further detail below, the power cutback levels applied by power cutback control function 50 are stored in and selected from look-up table 52, in response to certain parameters including feeder loop length L_{feeder}, which is stored in CO-fed feeder length register 51 in this example. Optionally, the upstream power level as sensed by the receive side of digital transceiver 30 during initialization may also assist in determining the power cutback levels applied by power cutback control function 50.

These scaled and encoded symbols are applied to inverse Discrete Fourier Transform (IDFT) function 43, which associates each symbol with one subchannel in the transmission frequency band, and generates a corresponding number of time domain symbol samples according to the Fourier transform. If desired, a cyclic prefix or suffix may be applied to the modulated time-domain samples from IDFT function 43, to reduce intersymbol interference (ISI) as known in the art. The time-domain signal is converted into a serial sequence by converter 45, with such upsampling included as appropriate for the desired data rate, followed by digital filter function 26TX processing the digital datastream in the conventional manner to remove image components and voice band or ISDN interference. The filtered digital datastream signal is then applied to the analog front end (AFE) 34 for the corresponding port, for eventual transmission over facility TWP.

On the receive side, transceiver 30 effectively reverses the transmit processes, beginning with AFE 34 filtering and converting the received analog signals into the digital domain, and applying those signals to digital filter block 26RX as shown. Digital filter block 26RX augments the analog filters of AFE 34, and preferably also applies a time domain equalizer (TEQ) in the form of a finite impulse response (FIR) to shorten the effective length of the impulse response of the transmission channel. Serial-to-parallel converter 45 applies the datastream, as a block of samples, to Discrete Fourier Transform (DFT) function 47 (after the removal of any cyclic affix). DFT function 47 demodulates the DMT modulated symbols at each subchannel frequency, effectively reversing the modulating IDFT, and producing a frequency domain representation of the transmitted symbols multiplied by the frequency-domain response of the effective transmission channel. Frequency-domain equalization (FEQ) function 48 recovers the modulating signals by dividing out the frequency-domain response of the effective channel, and constellation decoder function 49 resequences the symbols into a serial bitstream, decoding the encoding applied prior to transmission, and forwards an output bitstream to fiber optic interface 32 in the form of a bitstream at baseband frequencies.

According to the preferred embodiment of the invention, power cutback control function 50 assists in the derivation of the gain values for each subchannel in the transmit DMT bandwidth applied by gain scaling function 42. These gain values applied by gain scaling function 42 are determined according to such factors as peak-to-average reduction, gain values communicated between transceivers in the initialization of the DSL session, and, according to the preferred embodiment of the invention, by a power cutback level for reducing FEXT on neighboring twisted-pair facilities TWP. The determination of this power cutback level, according to the preferred embodiment of the invention, will now be described in detail.

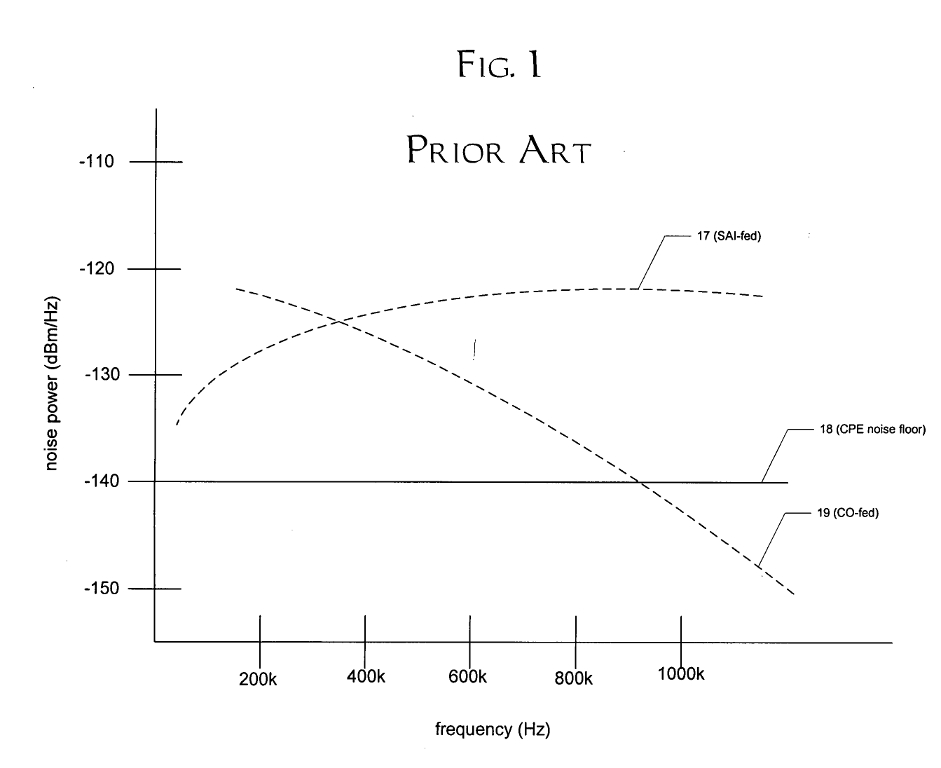

As shown in FIG. 1, the power of the SAI-fed FEXT at the CPE receiver of CO-fed communications is quite strong relative to the CO-fed FEXT at its own CPE receiver. According to this invention, therefore, it has been observed that the effects of SAI-fed FEXT on the CO-fed downstream communications will certainly dominate those caused by the CO-fed FEXT on the SAI-fed downstream communications. And it has been further observed that, if the CO-fed FEXT at the received power as shown in FIG. 1 is acceptable, the SAI-fed power could be substantially reduced while still providing acceptable downstream data rate performance to its clients, and that this power cutback would greatly reduce the SAI-fed FEXT on the CO-fed communications, thus increasing the CO-fed data rate at its CPE.

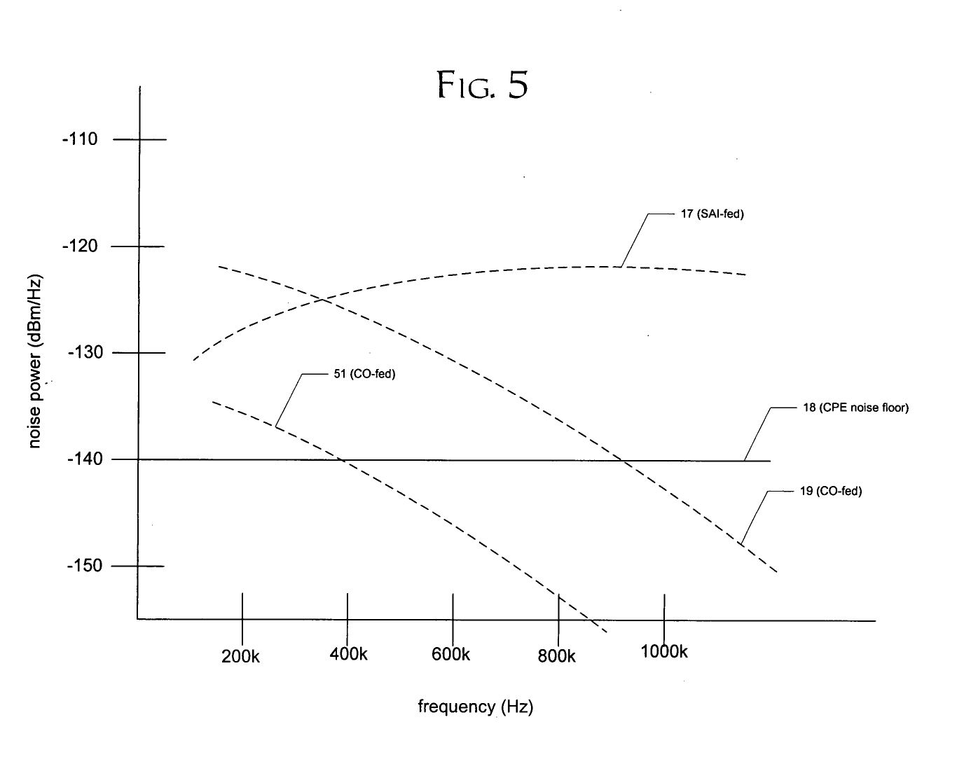

Referring to FIG. 5, curve 51 illustrates the PSD of CO-fed FEXT received at a CPE installation, in a system such as shown in FIG. 2, in which the feeder loop length L_{feeder} from CO 2₁ to SAI 5 is 9000 feet, and in which the distribution length L_{dist-CO} from SAI 5 to CPE 82 is 3000 feet. FIG. 5 also illustrates curve 19 from FIG. 1, which corresponds to CO-fed FEXT for a feeder loop length L_{feeder} of 6000 feet; curves 17 and 18 from FIG. 1 for the SAI-fed FEXT and CPE noise floor are also shown for reference. Assuming again that the CO-fed FEXT at CPE 82 is acceptable, it is therefore apparent that the SAI-fed power cutback can be increased (thus increasing the CO-fed data rate at CPE 8₁), before CO-fed FEXT on the SAI-fed signal becomes significant, as the feeder loop length L_{feeder} increases.

In addition, it has been observed that the power of the SAI-fed downstream signal can be cut back substantially without substantial loss of data rate, over relatively short distribution loops (e.g., on the order of 6000 feet). This is because the noise power, as received over such short loops, is dominated by FEXT, rather than by circuit noise in the receiving CPE itself. As such, and considering that reduction in transmit power not only reduces the amplitude of the signal but also reduces the amplitude of the noise in that signal, the SAI-fed transmit power can be reduced substantially (e.g., on the order of 20 dB in typical situations) before the CPE noise floor begins to cause loss of SAI-fed data rate. Accordingly, it is contemplated that the data rate performance of the SAI-fed signal will not substantially degrade over reasonable power cutback levels.

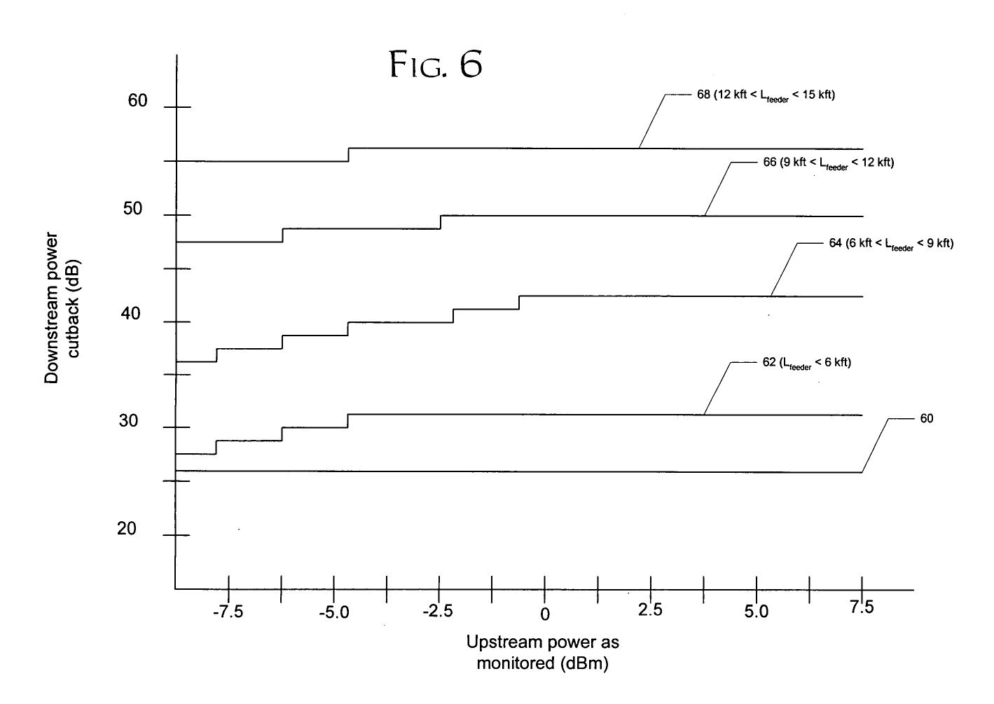

Accordingly, it has been discovered, according to the preferred embodiment of the invention, that the power, or PSD, of the SAI-fed signal can be cutback to a level that reduces its FEXT crosstalk as seen on CO-fed facilities in the same binder. It has been further discovered, according to this invention, that the level of this power cutback can be adjusted and optimized based on the feeder loop length L_{feeder} from the central office supporting the CO-fed communications over the twisted-pair facilities that are being carried over that binder. FIG. 6 illustrates an exemplary set of power cutback levels of the SAI-fed DSL communications according to the preferred embodiment of the invention, illustrating these observations.

Curves 62 through 68 of FIG. 6 illustrate the relationship of upstream power over the SAI-fed DSL communications facility (facility TWP2 of FIG. 2) versus the downstream power cutback applied to the SAI-fed communications, for various feeder loop lengths L_{feeder}, referring of course to the length of the CO-fed feeder loop to SAI 5 from CO 2₁ (FIG. 2). The power cutback levels shown in FIG. 6 are expressed in dB, and as such refer to a cutback from a given reference level, which in this example is −40 dBm/Hz. As known in the art, according to the various ADSL, ADSL2, and ADSL2+ standards, a power cutback level can be applied by DSL modems to their downstream transmissions based on the power level of the upstream signal, as sensed during initialization. As such, according to this embodiment of the invention, the overall power cutback depends both upon this sensed upstream power, and also on the feeder loop length L_{feeder}. As shown in FIG. 6, curve 62 illustrates relatively low power cutback levels where SAI 5 is located at a relatively short feeder loop length, L_{feeder}, in this case less than about 6000 feet, from the corresponding CO 2₁ that sources the CO-fed signals. Curve 60 illustrates the power cutback level for achieving a 6 Mbps data rate over 6000 feet of conventional 26 awg twisted pair wire, by way of reference; accordingly, for relatively short feeder loop lengths, the power cutback applied according to this exemplary implementation is near that level as shown by curve 62. Curve 64 illustrates a higher downstream power cutback level for longer feeder loop lengths L_{feeder} between 6000 and 9000 feet. For each of curves 62, 64, in this example, several power cutback steps are provided for increasing levels of sensed upstream power. Curves 66, 68 respectively illustrate increasing levels of power cutback on the SAI-fed downstream communications as the feeder loop length L_{feeder} lengthens further.

In the abstract, therefore, the power cutback to be applied to the SAI-fed downstream transmissions, by digital transceiver 30, depends on a parameter of an unrelated DSL facility and communication, specifically the feeder loop length L_{feeder} of the CO-fed DSL subscriber loop carried over a neighboring facility. However, as is fundamental in the art, SAI 5 is typically deployed at a fixed physical location, as is each of the central offices 2₁, 2₂. The feeder loop length L_{feeder} between SAI 5 (through which the CO-fed loop passes) and CO 2₁ sourcing the CO-fed downstream transmissions thereover is therefore a known, and fixed, value. All other parameters relating to the desired power cutback level (e.g., upstream power) can be determined in initialization of a DSL session, or during a periodic re-analysis of the loop. Accordingly, the determination of the power cutback to be applied to SAI-fed downstream transmissions, in order to reduce FEXT interference on neighboring CO-fed communications, can be readily carried out by digital transceiver 30 in DSL modem 6 of SAI 5.

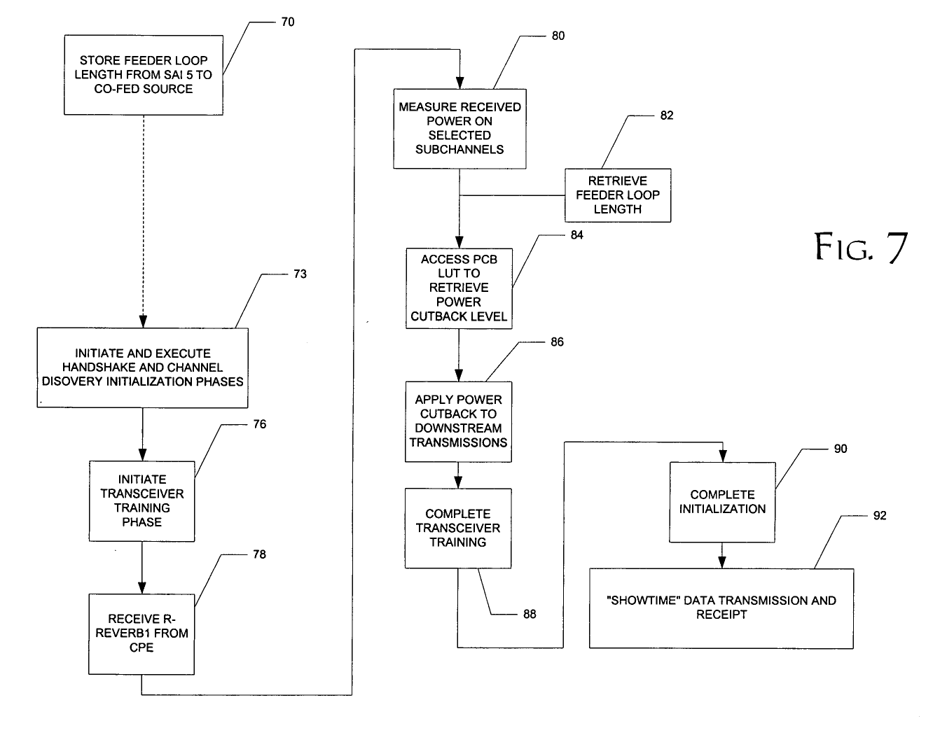

Referring now to FIG. 7, the operation of digital transceiver 30 of FIGS. 3 and 4 in applying power cutback levels to its downstream communications will now be described in detail. In process 70, a parameter corresponding to the feeder loop length L_{feeder} between SAI 5 and CO 2₁, from which downstream CO-fed communications are sourced over a feeder loop TWPF to SAI 5, and over which these communications are conveyed over distribution loop TWP1 that is near to, and perhaps within the same binder 4 as, the facility TWP2 over which digital transceiver 30 sources SAI-fed communications to its CPE 82. As described above, the location of CO 2₁ and SAI 5 are, of course, fixed, as is the feeder loop length L_{feeder}, and as such this parameter may be stored in digital transceiver 30 in process 70 well prior to the initialization of a DSL session. Indeed, it is contemplated that storing process 70 may be carried out according to any number of techniques, including writing or programming an addressable memory location within digital transceiver 30 (e.g., CO-fed feeder length register 51 of FIG. 4, or memory resource 24 of FIG. 2) from CO 2₂ over fiber optic facility FO, programming such an addressable memory location locally at SAI 5 during a service call, physically placing a memory device (programmable ROM, or flash memory card) into SAI 5 with the appropriate parameter value, and the like. Indeed, storing process 70 may inferentially apply the parameter value, for example by way of a service technician connecting a jumper wire or setting a switch within SAI 5 so that a selected one of multiple look-up table resources (containing a corresponding set of power cutback levels) are accessed during operation, or by selecting a particular field-installable memory device (ROM or flash memory) containing the selected power cutback look-up table. It is contemplated that those skilled in the art having reference to this specification will recognize these and other alternative ways in which storing process 70 may be carried out, within the scope of the invention.

In process 73, a DSL communications session commences, in this example, by way of the initiation and execution of handshaking and channel discovery initialization phases, according to the conventional processes for such initialization according to the particular standard, or proprietary methods, as the case may be. This initialization process, and also the other processes illustrated in FIG. 7 and described herein, are carried out by digital transceiver 30 of DSL modem 6 in SAI 5, in cooperation with CPE 82 for the corresponding DSL communications loop. For a description of examples of initialization processes, including process 73 and the like, attention is directed to Asymmetric digital subscriber line transceivers (ADSL), ITU-T Recommendation G.992.1 (International Telecommunications Union, June 1999); Asymmetric digital subscriber line transceivers 2 (ADSL2), ITU-T Recommendation G.992.3 (International Telecommunications Union, July 2002); and Asymmetric Digital Subscriber Line (ADSL) transceivers—Extended bandwidth ADSL2 (ADSL2+), Recommendation G.992.5 (International Telecommunications Union, May 2003), each incorporated herein by this reference. Following the execution of the handshake and channel discovery phases in process 73, the transceiver training initialization phase is initiated in process 76. This transceiver training phase performs such operations as timing, frequency, and frame synchronization of the CPE transceiver to digital transceiver 30, setting of automatic gain control (AGC) levels, echo cancellation training, and the like.

During the transceiver training phase, process 78 is executed by way of which digital transceiver 30 receives a predetermined sequence from CPE 82 by way of which the upstream power level is determined in process 80. For example, as carried out according to the ADSL standard, the sequence used for upstream power monitoring is the “R-REVERB1” sequence; digital transceiver 30 monitors the power levels on certain subchannels to determine the upstream power levels. These measured upstream power levels, together with a feeder loop length value that is retrieved (either expressly, or inferentially) in process 82, determine the downstream power cutback levels to be applied by digital transceiver 30.

According to this embodiment of the invention, the power cutback level for downstream transmissions is then determined by power cutback control function 50, such a determination based at least on the retrieved feeder loop length L_{feeder} from process 82, and optionally on other factors such as the measured received upstream power from process 80. According to this exemplary implementation, power cutback control function 50 generates a look-up table address corresponding to the retrieved feeder loop length L_{feeder} and corresponding to other optional factors such as the measured received upstream power. Power cutback look-up table 52 corresponds to a portion of memory resource 24 (FIG. 3) in which power cutback values are stored at addressable locations. These power cutback values are preferably derived prior to implementation of SAI 5 according to an acceptance criterion the desired amount of power cutback, and thus the desired level of FEXT reduction.

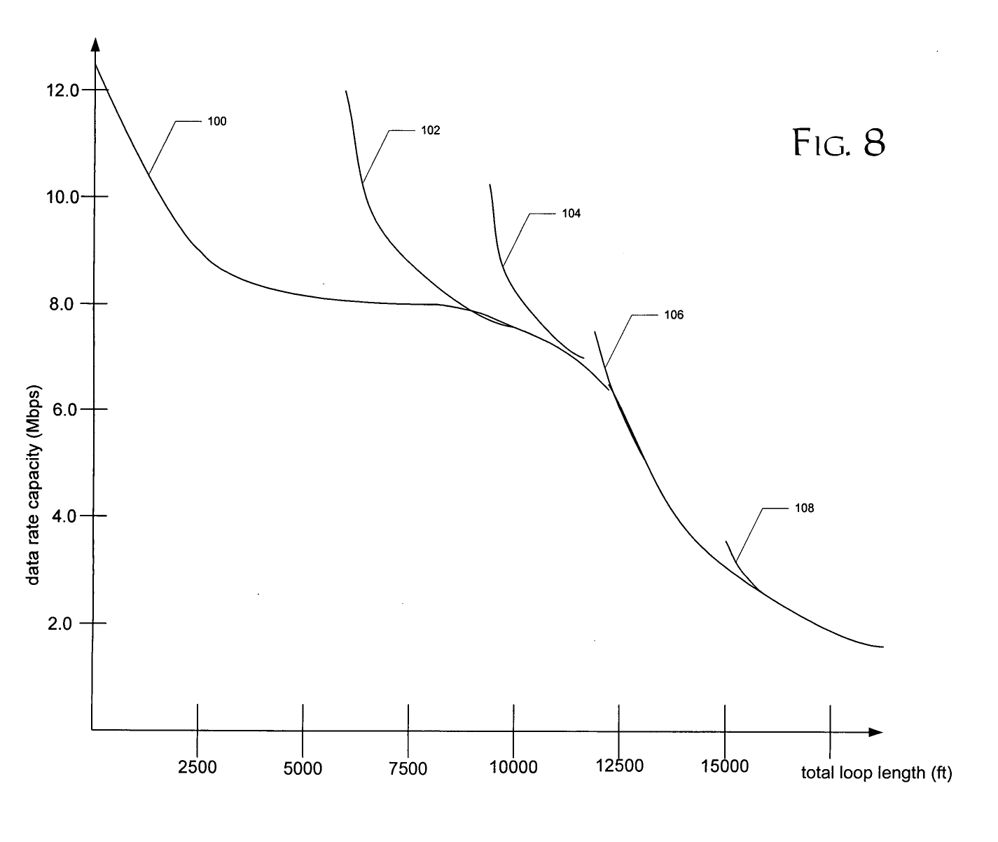

In general, a useful acceptance criterion ensures that the CO-fed data rate as received by a given CPE is not degraded any worse by SAI-fed interferers in a common binder than it would be by the same number of CO-fed interferers in that binder. According to a first preferred embodiment of this invention, therefore, the acceptance criterion determines the data capacity of a CO-fed DSL communication with a given number of CO-fed interferers at the same loop length (feeder and distribution), and derives a power cutback level on downstream SAI-fed communications so that replacement of all of the CO-fed interferers with SAI-fed interferers (with power cutback) does not degrade the CO-fed data rate. FIG. 8 illustrates a plot in which curve 100 illustrates the CO-fed data capacity over total loop length (feeder plus distribution) for DSL communications, assuming twenty-four CO-fed interferers. Curve 102 illustrates the CO-fed data capacity versus total loop length for a feeder loop length L_{feeder} of 6000 feet, in which twenty-four SAI-fed interferers are present, but applying the power cutback levels illustrated in FIG. 6. Similarly, curves 104, 106, 108 illustrate the CO-fed data capacity versus total loop length for feeder loop length L_{feeder} of 9000 feet, 12000 feet, and 15000 feet, respectively, also with twenty-four SAI-fed interferers, each with the power cutback levels (from −40 dBm) as illustrated in FIG. 6. As evident from the plots of FIG. 8 in this example, the acceptance criterion of no loss of data capacity or data rate due to increased FEXT from SAI-fed loops replacing CO-fed loops can be attained with application of the proper power cutback levels to the SAI-fed downstream transmissions. And referring to the method of FIG. 7, power cutback look-up table 52 preferably stores the corresponding power cutback levels as illustrated in FIG. 6, for attaining the acceptance criterion and performance illustrated in FIG. 8.

Logic circuitry or functionality is provided within digital transceiver 30 (e.g., within DSP subsystem 25) to derive a look-up table address from the retrieved and measured parameters, and apply this address to power cutback look-up table 52 to retrieve the corresponding downstream power cutback levels to be used, in process 84 of FIG. 7. In process 86, power cutback control function 50 applies these power cutback levels to gain scaling function 42 (FIG. 4), preferably by deriving the corresponding gain values to be applied to each subchannel prior to IDFT modulation. These power cutback levels, determined in processes 82, 84 according to this preferred embodiment of the invention, are applied in the same manner as conventional power cutback levels (based solely on upstream power) are applied according to the ADSL, ADSL2, ADSL2+ standards incorporated by reference above. As such, it is contemplated that those skilled in the art having reference to this specification will be readily able to implement this power cutback functionality, without undue experimentation.

According to the example of the preferred embodiment of the invention described above, the acceptance criteria defining the power cutback levels to be applied, for a given installation, is that the CO-fed communications are to be no worse off, from a FEXT standpoint, as a result of SAI-fed loops being realized in the same binder, relative to the binder carrying all CO-fed loops. It is of course contemplated that other acceptance criteria may alternatively be used, resulting in different power cutback levels applied in process 86. For example, the acceptance criteria may be defined to favor the SAI-fed data rate, at the expense of the CO-fed data rate, for example by estimating the power cutback so that the total noise on the CO-fed loop is an arbitrary level (e.g., 1 db) worse with all other loops in the binder being SAI-fed than the total noise would be with all other loops in the binder being CO-fed. As a result, the data rate over the CO-fed loop will be theoretically degraded upon the deployment and concurrent operation of the SAI-fed loops in the same binder. However, in practice, the degradation due to any increased FEXT from the SAI-fed loops may not be as bad as this theoretical level, because the increased FEXT noise may still be below the internal CPE noise level at many frequencies, in which case the effects from the increased FEXT may be minimal. It is contemplated that other acceptance criteria, upon which the power cutback levels may be defined, may alternatively be used, and will be apparent to those skilled in the art having reference to this specification.

According to another preferred embodiment of the invention, the power cutback levels for downstream transmissions applied in process 86 are frequency dependent levels. As evident from FIG. 5, the power of received CO-fed signals falls below the internal CPE noise level at higher frequencies, for example above about 950 MHz in that example. In that higher frequency portion of the spectrum, reduction in the FEXT by power cutback of the SAI-fed signals will have little effect, because the CO-fed data rate is substantially limited by the internal noise of the CPE anyway. According to this alternative embodiment of the invention, therefore, the power cutback levels applied in process 86 depend on subchannel frequency, such that higher frequency subchannels of the SAI-fed downstream transmissions will have their power cut back less at higher frequencies than will the lower frequency subchannels. The characteristic of this frequency-dependent power cutback can be pre-characterized and stored in power cutback look-up table 52, or alternatively may be based on the results of the channel discovery or other initialization process. As a result of this frequency-dependent power cutback approach, it is contemplated that, in many situations, neither the CO-fed data rate nor the SAI-fed data rate will be sacrificed relative to one another.

As mentioned above, it is highly desirable for the circuitry within service area interfaces to be powered from the transmitted signal itself, so that external power need not be routed to (and metered at) each service area interface location. Of course, this self-powering of DSL modem circuitry at the SAI is facilitated by minimizing the power consumption of the DSL modem itself. Indeed, because the power of transmitted signals over fiber optic facilities and the like are themselves constrained, excessive power requirements of the circuitry at the SAI may prohibit such self-powering operation.

According to the preferred embodiment of the invention, however, the power cutback applied to downstream SAI-fed communications in process 86 has the additional benefit of reducing the power consumption of DSL modem 6 (FIG. 3). This power reduction derives primarily from a reduction in the power consumed by AFE 34 in driving high power signals, because the power of the signals driven by AFE 34 is a large factor in the overall power consumption of DSL modem 6. In addition, it is contemplated that the power cutback levels applied in process 86 may also be selected not only to limit the FEXT on neighboring CO-fed signals, but also to maintain the power consumption of transceiver 30 and especially of line driver circuitry in AFE 34, both in DSL modem 6, at a level that can be readily powered by way of a DC feed from the central office, indeed at a level that can be powered by battery backup resources at that central office. In this case, the power cutback levels applied in process 86 may be constrained so that the output power does not exceed this power consumption level, even if the SAI-fed crosstalk acceptance criteria would allow a higher signal power.

According to an alternative embodiment of the invention, it is contemplated that this power minimization may be selected so that hybrid circuit 39 in AFE 34 may be omitted. As mentioned above, relative to FIG. 3, hybrid circuit 39 is provided so that the signals being transmitted by line driver and receiver 37 are separated from, and do not interfere with, signals being received by line driver and receiver 37. Such interference is present even considering the frequency division duplexing between the upstream and downstream transmissions in DSL communications. However, it has been observed that the power consumption by hybrid circuit 39 can be a substantial factor in the overall power consumption of DSL modem 6. It is therefore contemplated, according to this embodiment of the invention, that the power cutback levels applied to the downstream transmissions may be sufficient to ensure that the transmitted signal will not substantially interfere with the received upstream signal in the absence of hybrid circuit 39, given the different frequency bands of the upstream and downstream transmissions. This power reduction cutback level may be an additional constraint in the selection of the power cutback levels to be applied in process 86, and may further reduce the SAI-fed downstream power below that necessary to minimize FEXT on adjacent CO-fed loops.

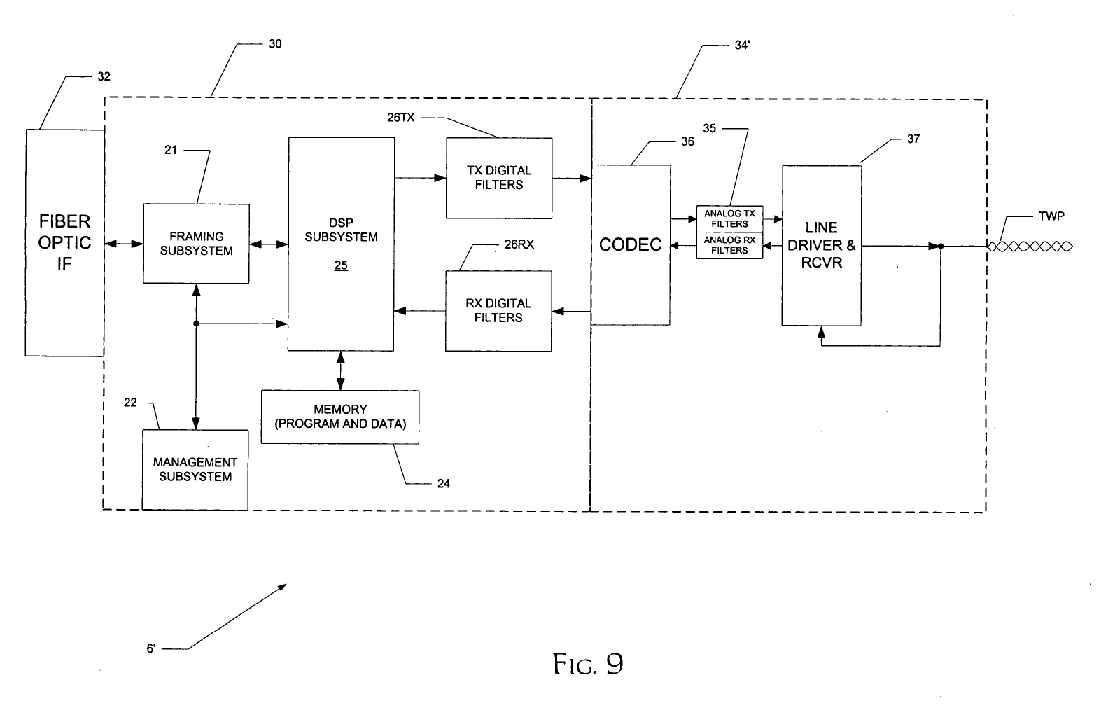

Accordingly, as shown in FIG. 9, DSL modem 6′ according to this embodiment of the invention includes digital transceiver 30, as before, but includes modified AFE 34′ that simply has the transmit output and receive input of line driver and receiver 27 hardwired together and connected to twisted-pair wire facility TWP. No hybrid circuit is included in AFE 34′ in this example. Preferably, the downstream transmit power is maintained sufficiently low that conventional CMOS levels may be driven by line driver and receiver 37, thus also eliminating high voltage line driver circuitry and further reducing the power consumption by DSL modem 6′. It is contemplated that DSL modem 6′ of FIG. 9 will therefore consume substantially less power than DSL modem 6, even at the same PSD for the downstream transmissions. The ability to power DSL modem 6′ from the signals communicated over fiber optic facility FO is therefore enhanced, according to this embodiment of the invention.

Referring back to FIG. 7, following the applying of power cutback levels to downstream transmissions in process 86, the initialization of the DSL communications session may continue. Transceiver training is completed at both DSL modem 6 and the CPE 82, in the conventional manner, in process 88. Such transceiver training includes the arranging and setting of various equalizer circuitry (frequency domain and time domain equalizers), and the like as known in the art. DSL initialization process 90 then completes the other conventional operations involved in the initialization session, including the exchange phase and the like; it is contemplated that those skilled in the art are familiar with such additional initialization processes, procedures, and protocols.

In process 92, the communication of actual payload data between DSL modem 6, 6′ at SAI 5 and CPE 82 is carried out, in the phase referred to in the art as “showtime”. According to this embodiment of the invention, as described in detail above, the downstream transmissions are performed with the power cutback levels determined to minimize FEXT on adjacent CO-fed DSL loops in the same binder, and also for power reduction as appropriate. Upstream communications are carried out in the conventional manner for “showtime”.

As known in the art, periodic monitoring and maintenance of the DSL session may be periodically performed during “showtime” phase 92. To the extent that conditions change over the channels that may cause changes in the power cutback levels for FEXT reduction, for example by changing the received upstream power levels over the DSL channels, the power cutback levels may be adjusted by repeating processes 80, 84, 86 as a result.

As evident to those skilled in the art having reference to this specification, this invention provides many important advantages in digital communications. The “near-far” problem, in which far-end crosstalk (FEXT) is dominated by physically close signal sources, is addressed by this invention, because the transmit power levels for the nearer transmitter are reduced by an amount based, at least in part, on the expected attenuation on the DSL loop that is vulnerable to the FEXT. It is therefore contemplated that this invention can enable the CO-fed transmissions to be unaffected, from a data rate performance standpoint, by the implementation of service area interface driven communications in the neighborhood. In addition, the power cutback according to this invention can reduce the power consumed at the service area interface, thus enabling the realization of DSL transmitters in the neighborhood that are powered from the central office by way of a DC power feed, at a level that can be supported by battery backup if needed.

As a result of this invention, therefore, it is contemplated that digital communications via fiber optic facilities can be deployed sooner in many neighborhoods. Because of this invention, it is not necessary to disrupt existing CO-fed DSL subscribers in order to implement the newer architecture communications, nor is it necessary to wait until all subscribers are converted to the SAI architecture.

And according to this invention, these benefits are attained in a manner that is completely transparent to customer premises equipment. As such, these benefits do not require replacement or updating of the customer premises equipment, nor does this invention involve the training processes that are to be performed at the CPE. Indeed, it is contemplated that this invention can be realized in the field without noticeable changes to or at the client-side modems.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of establishing a digital subscriber line communications link with a subscriber, from a location disposed at a feeder distance from a first central office, comprising:
initializing communications with the subscriber over a first communications facility;
determining a power cutback level for transmissions to the subscriber based on the feeder distance; and
transmitting payload data received from a second central office to the subscriber over the first communications facility according to the power cutback level.

2. The method of claim 1, wherein the payload data is received over a fiber optic communications facility;
and wherein the first communications facility comprises twisted-pair wire.

3. The method of claim 1, wherein the initializing, determining, and transmitting steps are performed by a digital subscriber line modem at a service area interface;
wherein the first communications facility comprises twisted-pair wire.
and wherein communications from the first central office are received by the service area interface over a feeder facility comprising twisted-pair wire, and are forwarded from the service area interface to a second subscriber from the service area interface over a second communications facility comprising twisted-pair wire.

4. The method of claim 1, wherein the initializing, determining, and transmitting steps are performed by a digital subscriber line modem at a service area interface;
and further comprising:
storing, in memory at the service area interface, a parameter value indicating the feeder distance; and
before the determining step, retrieving the stored parameter value indicating the feeder distance.

5. The method of claim 4, further comprising:
during the initializing step, measuring the power of signals received from the subscriber over the first communications facility;
and wherein the determining step determines the power cutback level based on the feeder distance and based on the measured power.

6. The method of claim 1, wherein the determining step is performed during the initializing step.

7. The method of claim 1, wherein the transmitting step transmits payload data over a plurality of subchannels;
and wherein the determining step determines power cutback levels that vary over the plurality of subchannels.

8. A digital subscriber line modem for a service area interface located at a feeder distance from a first central office, comprising:
an upstream interface, for coupling to a data source;
an analog front end, for coupling to a subscriber via a first distribution communications facility;
a digital transceiver, coupled to the upstream interface and to the analog front end, for digitally processing data corresponding to signals received at the upstream interface and to be transmitted to the subscriber, the digital transceiver comprising:
circuitry for associating digital data corresponding to the signals to be transmitted with a plurality of subchannels;
gain scaling circuitry for applying gain to the signals to be transmitted over the plurality of subchannels according to a power cutback level that corresponds to the feeder distance; and
modulation circuitry for modulating the plurality of subchannels according to the digital data to be transmitted.

9. The modem of claim 8, wherein the transceiver further comprises:
power cutback control circuitry, for selecting the power cutback level to be applied to the gain scaling circuitry.

10. The modem of claim 9, wherein the transceiver further comprises:
a power cutback level look-up table, for storing a plurality of power cutback levels to be applied to the gain scaling circuitry;
wherein the power cutback control circuitry selects from among the plurality of power cutback levels responsive to the feeder distance.

11. The modem of claim 10, wherein the transceiver further comprises:
a memory for storing the feeder distance.

12. The modem of claim 10, wherein the transceiver further comprises:
a memory for storing the feeder distance.

13. The modem of claim 9, wherein the transceiver further comprises:
a power cutback level look-up table, for storing a plurality of power cutback levels to be applied to the gain scaling circuitry, each of the plurality of power cutback levels including varying power cutback values over the plurality of subchannels.
wherein the power cutback control circuitry selects from among the plurality of power cutback levels responsive to the feeder distance.

14. The modem of claim 8, wherein the transceiver comprises:
programmable logic circuitry; and
program memory for storing instructions executable by the programmable logic circuitry, so that the programmable logic circuitry operates as the encoding circuitry, the gain scaling circuitry, and the modulation circuitry.

15. The modem of claim 8, wherein the analog front end comprises:
a line driver and transceiver circuit, having an output and an input coupled to the first distribution communications facility.

16. The modem of claim 15, wherein the analog front end comprises a hybrid circuit for coupling the line driver and transceiver circuit to the first distribution communications facility.

17. The modem of claim 8, wherein the transceiver further comprises:
circuitry for digitally processing signals received from the subscriber over the first distribution communications facility, the digital processing comprising measuring the power of the received signals during initialization of a communications session.

18. The modem of claim 17, wherein the transceiver further comprises:
power cutback control circuitry, coupled to the circuitry for digitally processing received signals, for selecting the power cutback level to be applied to the gain scaling circuitry responsive to the feeder distance, and also responsive to the measured power of the received signals during initialization.

19. The modem of claim 8, wherein the upstream interface is for coupling to a data source via a fiber optic facility;
and wherein the first distribution facility comprises twisted-pair wire within a binder.

20. The modem of claim 19, wherein the first central office is coupled to a second subscriber via a first feeder facility, comprising twisted-pair wire, disposed between the first central office and the service area interface, and via a second distribution facility, comprising twisted-pair wire, disposed in the binder with the first distribution facility.
